(19) United States
(12) Patent Application Publication
(10) Pub. No.: US 2021/0082205 A1
(43) Pub. Date: Mar. 18, 2021

(54) VEHICLE COMMUNICATION DEVICE, PARKING LOT COMMUNICATION DEVICE, AND PARKING LOT MANAGEMENT SYSTEM

(71) Applicant: DENSO CORPORATION, Kariya-city (JP)

(72) Inventors: Yukie TERAO, Kariya-city (JP); Motohiko WATANABE, Kariya-city (JP); Haruhiko KAKITSU, Kariya-city (JP)

(21) Appl. No.: 17/104,821

(22) Filed: Nov. 25, 2020

Related U.S. Application Data
(63) Continuation of application No. PCT/JP2019/013587, filed on Mar. 28, 2019.

(30) Foreign Application Priority Data
May 28, 2018 (JP) 2018-101420

(51) Int. Cl. G07B 15/00; G08G 1/14

(52) U.S. Cl. CPC G07B 15/00; G08G 1/148; G08G 1/143; G08G 1/144

(57) ABSTRACT

A vehicle communication device equipped to a vehicle receives parking space identification information from a parking lot communication device, transmits vehicle identification information of the vehicle to the parking lot communication device, and transmits, to an information processing device positioned outside of the vehicle, the received parking space identification information and the vehicle identification information. A parking lot communication device installed to each parking space of a parking lot: receives, from the vehicle communication device, the vehicle identification information; transmits, to the vehicle communication device, the parking space identification information used for identifying the parking space to which the parking lot communication device is installed; and transmits the received vehicle identification information and the parking space identification information to an information processing device positioned outside of the parking lot communication device.

### CROSS REFERENCE TO RELATED APPLICATIONS

The present application is a continuation application of International Patent Application No. PCT/JP2019/013587 filed on Mar. 28, 2019, which designated the U.S. and claims the benefit of priority from Japanese Patent Application No. 2018-101420 filed on May 28, 2018. The entire disclosures of all of the above applications are incorporated herein by reference.

### TECHNICAL FIELD

The present disclosure relates to a vehicle communication device, a parking lot communication device, and a parking lot management system.

### BACKGROUND

There has been known various parking lot systems which support automatic payment of parking fee using communication lines, such as the Internet.

### SUMMARY

A vehicle communication device equipped to a vehicle receives parking space identification information from a parking lot communication device, transmits vehicle identification information of the vehicle to the parking lot communication device, and transmits, to an information processing device positioned outside of the vehicle, the received parking space identification information and the vehicle identification information. A parking lot communication device installed to each parking space in a parking lot: receives, from the vehicle communication device, the vehicle identification information; transmits, to the vehicle communication device, the parking space identification information used for identifying the parking space to which the parking lot communication device is installed; and transmits the received vehicle identification information and the parking space identification information to an information processing device positioned outside of the parking lot communication device.

### BRIEF DESCRIPTION OF DRAWINGS

Objects, features and advantages of the present disclosure will become apparent from the following detailed description made with reference to the accompanying drawings. In the drawings:

FIG. 1 is a diagram showing devices included in a parking lot management system according to embodiments of the present disclosure;

FIG. 2 is a diagram showing a vehicle communication device and a parking lot communication device according to embodiments of the present disclosure;

FIG. 3 is a block diagram showing a driver management server and a parking lot management server according to embodiments of the present disclosure;

FIG. 4 is a sequence diagram showing a processing executed by the parking lot management system according to a first embodiment of the present disclosure;

FIG. 5 is a sequence diagram showing a processing executed by the parking lot management system according to a second embodiment of the present disclosure;

FIG. 6 is a diagram showing a vehicle communication device and a parking lot communication device according to another embodiment of the present disclosure;

FIG. 7 is a sequence diagram showing a processing executed by the parking lot management system according to another embodiment of the present disclosure; and

FIG. 8 is a diagram showing a vehicle communication device according to another embodiment of the present disclosure.

### DETAILED DESCRIPTION

With advancement of unmanned parking lots, various parking lot systems support automatic payment of parking fee using communication lines, such as the Internet.

For example, a service enables a reservation of a parking lot on a web system using the Internet and also enables payment of parking fee based on the reservation.

In such a service, it is hard to confirm on the system whether a vehicle used or managed by the user who made the reservation is parked in an actual parking space of the parking lot.

The following system is also known.

In the parking lot, a sensor or a beacon transmitter is equipped to each parking space. In response to a parking of a vehicle in the parking space, the sensor detects the vehicle and records parking start time. The beacon transmitter transmits a beacon to start an application installed in a portable terminal. A user of the parking lot reserves (reports usage of) the parking lot using the application, and pays the parking fee based on the reservation details.

In this system, the reservation is made under the self-report by the user. For a user who does not make the reservation even though the vehicle is parked in the parking lot, it is difficult to charge the parking fee.

In a known parking lot management system, a parking lot system including the sensor arranged in each parking space is separate from a vehicle system including a vehicle communication device and an electronic control device of the vehicle. In such a current system, the inventors of the present application found that identification of each parking space including presence of the vehicle in the parking space, identification of a vehicle parked in the parking space, and identification of a user are not linked to each other. As a result, the parking management system may fail to accurately and reliably execute the automatic payment of the parking fee.

According to one aspect of the present disclosure, a vehicle communication device equipped to a vehicle includes: a first communication unit receiving parking space identification information from a parking lot communication device and transmitting vehicle identification information used for identifying the vehicle to the parking lot communication device, the parking lot communication device being installed to each parking space in a parking lot; and a second communication unit transmitting, to an information processing device positioned outside of the vehicle, the parking space identification information that is received and the vehicle identification information.

According to another aspect of the present disclosure, a parking lot communication device installed to each parking space in a parking lot includes: a first communication unit receiving, from a vehicle communication device equipped to a vehicle, vehicle identification information used for identifying the vehicle, and the first communication unit transmitting, to the vehicle communication device, parking space identification information used for identifying a parking space to which the parking lot communication device is installed; and a second communication unit transmitting the vehicle identification information that is received and the parking space identification information to an information processing device positioned outside of the parking lot communication device.

According to another aspect of the present disclosure, an information processing device that communicates with a vehicle communication device equipped to a vehicle is provided. The vehicle communication device includes: a first communication unit receiving first parking space identification information from a parking lot communication device and transmitting vehicle identification information used for identifying the vehicle to the parking lot communication device, the parking lot communication device being installed to each parking space in a parking lot; and a second communication unit transmitting, to the information processing device positioned outside of the vehicle, the first parking space identification information that is received and the vehicle identification information. The information processing device includes: a first storage storing the first parking space identification information and the vehicle identification information which are transmitted from the vehicle communication device; a second storage storing user identification information acquired in response to a user inputting a request to use the parking lot, payment information which is correlated to the user identification information, and second parking space identification information of a parking space which is allowed to the user for vehicle parking; a third storage storing the first parking space identification information transmitted from a parking lot management server that communicates with the parking lot communication device; and a calculator calculating parking fee according to the payment information in response to the parking space specified by the first parking space identification information being identical to the parking space specified by the second parking space identification information.

According to another aspect of the present disclosure, an information processing device which communicates with a parking lot communication device installed to each parking space in a parking lot is provided. The parking lot communication device includes: a first communication unit receiving, from a vehicle communication device equipped to a vehicle, vehicle identification information used for identifying the vehicle, and the first communication unit transmitting, to the vehicle communication device, first parking space identification information used for identifying a parking space to which the parking lot communication device is installed; and a second communication unit transmitting the vehicle identification information that is received and the first parking space identification information to the information processing device positioned outside of the parking lot communication device. The information processing device includes: a first storage storing the vehicle identification information and the first parking space identification information which are transmitted from the parking lot communication device; a second storage storing user identification information acquired in response to a user inputting a request to use the parking lot, payment information which is correlated to the user identification information, and second parking space identification information of a parking space which is allowed to the user for vehicle parking; and a calculator calculating parking fee according to the payment information in response to the parking space specified by the first parking space identification information being identical to the parking space specified by the second parking space identification information.

According to another aspect of the present disclosure, a parking lot management system includes: a vehicle communication device equipped to a vehicle; and an information processing device positioned outside of the vehicle.

According to another aspect of the present disclosure, a parking lot management system includes: a parking lot communication device installed to each parking space of a parking lot; and an information processing device positioned outside of the parking lot communication device.

According to another aspect of the present disclosure, a vehicle communication device equipped to a vehicle includes: a receiver receiving, from an information processing device, first parking space identification information and second parking space identification information, the first parking space identification information being designated by a user in a reservation of a parking lot, the second parking space identification information being transmitted from a parking lot communication device to the information processing device, each of the first parking space identification information and the second parking space identification information indicating a parking space of the parking lot and being communicated between the parking lot communication device installed to each parking space of the parking lot and the information processing device positioned outside of the parking lot communication device; a controller comparing the first parking space identification information with the second parking space identification information; and a transmitter transmitting vehicle identification information used for identifying the vehicle to the information processing device in response to the first parking space identification information being identical to the second parking space identification information.

With the above vehicle communication device, the parking lot communication device, and the parking lot management system including the vehicle communication or the parking lot communication device, the automatic payment of parking fee can be accurately and reliably executed by using the vehicle communication device and the parking lot infrastructure.

The following will describe embodiments of the present disclosure with reference to the drawings.

In the present disclosure, the configuration disclosed in each embodiment is not limited to each embodiment alone, but may be combined across the embodiments. For example, the configuration disclosed in one embodiment may be combined with another embodiment. The configurations disclosed in each embodiment may be integrated or combined together.

(Configuration of Parking Lot Management System)

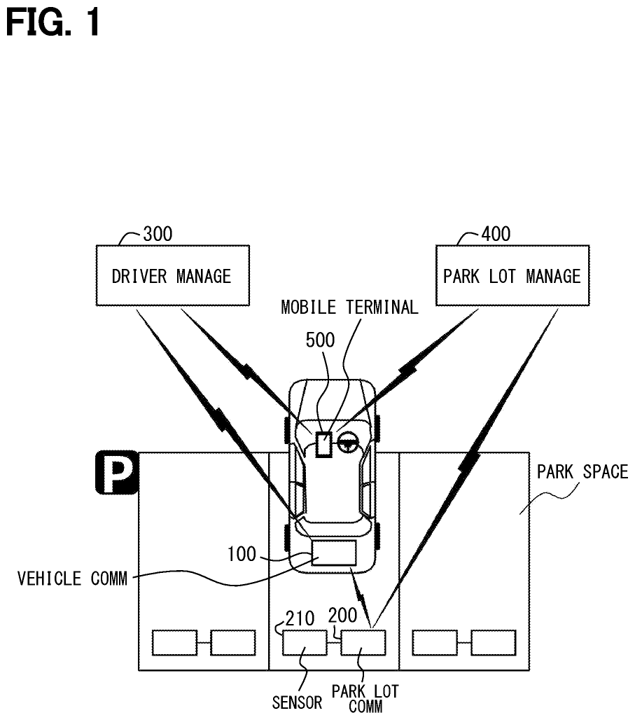

The following will describe devices included in a parking lot management system according to multiple embodiments of the present disclosure with reference to FIG. 1.

The parking lot management system includes a vehicle communication device 100 equipped to a vehicle. The vehicle communication device 100 communications with a parking lot communication device 200 and a driver management server 300.

The parking lot communication device 200 is equipped to each parking space of a parking lot, and communicates with the vehicle communication device 100 and a parking lot management server 400. A presence detection sensor 210 is also equipped to each parking space. In response to detecting of a vehicle in the parking space, the presence detection sensor 210 transmits a vehicle detection signal to the parking lot communication device 200. The parking lot communication device 200 is also referred to as a parking lot wireless communication device.

The driver management server 300 corresponds to an information processing device that manages information on a vehicle and a driver who is a user of the vehicle.

The parking lot management server 400 corresponds to an information processing device that manages information about usage state of the parking lot.

A mobile information terminal 500 is carried by the driver who is the user of the vehicle, and communicates with the driver management server 300 and the parking lot management server 400. The terminal may be implemented as, but is not limited to, a mobile phone, a tablet, a smartphone, a personal computer, and the like.

The vehicle communication device 100, the parking lot communication device 200, the driver management server 300, and the parking lot management server 400 may be implemented by a single device, or may be implemented by combination of multiple devices.

As long as the parking lot has a space for parking the vehicles, a subject and a place of the parking lot or the number of parking spaces are not specifically defined. The parking lot may include a parking lot set along a roadside.

(Vehicle Communication Device, Parking Lot Communication Device, and Communication Method)

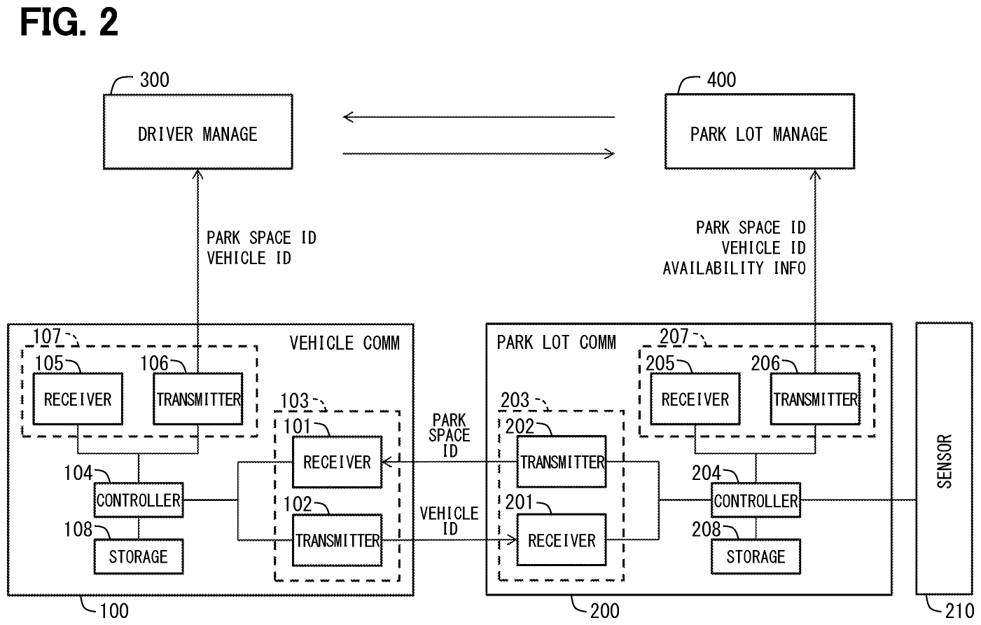

The following will describe the vehicle communication device 100 and the parking lot communication device 200 according to multiple embodiments of the present disclosure with reference to FIG. 2.

The vehicle communication device 100 includes a first communication unit 103, a controller 104, a second communication unit 107, and a storage 108. The first communication unit 103 includes a first receiver 101 and a first transmitter 102. The second communication unit 107 includes a second receiver 105 and a second transmitter 106.

The first communication unit 103 communicates with the parking lot communication device 200. The first receiver 101 of the first communication unit 103 receives parking space identification information (also referred to as parking space ID) that identifies the parking space where the vehicle is parked in the parking lot. The first transmitter 102 of the first communication unit 103 transmits vehicle identification information (also referred to as vehicle ID) that identifies the vehicle.

In the present disclosure, the identification information used to identify the parking space or the vehicle may include information that directly identifies the parking space or the vehicle. Alternatively, the identification information may also include information that indirectly identifies the parking space or the vehicle by calculation.

Receiving of the parking space identification information and the transmitting of the vehicle identification information may be executed in any order.

The second communication unit 107 communicates with the driver management server 300 provided outside the vehicle. The driver management server 300 corresponds to an information processing device in the present disclosure. Specifically, the second transmitter 106 of the second communication unit 107 transmits the parking space identification information received by the first receiver 101 and the vehicle identification information to the driver management server 300.

The information processing device in the present disclosure is able to manage and store the received parking space identification information, or execute a process based on the parking space identification information. The information processing device may have different name and implementation form.

Transmitting to the information processing device includes a direct transmission to the information processing device and an indirect transmission to the information processing device via one or more entities.

The controller 104 controls the first communication unit 103 and the second communication unit 107, and manages the information transmitted from or received by the first communication unit 103 and the second communication unit 107. The controller 104 stores, in the storage 108, or reads out, from the storage 108, the information transmitted from or received by the first communication unit 103 and the second communication unit 107.

The storage 108 stores information necessary for the vehicle. For example, the vehicle identification information for identifying the vehicle is stored in the storage 108. The vehicle identification information is read out from the controller 104, and transmitted by the first transmitter 102 and the second transmitter 106.

The parking lot communication device 200 includes a first communication unit 203, a controller 204, a second communication unit 207, and a storage 208. The first communication unit 203 includes a first receiver 201 and a first transmitter 202. The second communication unit 207 includes a second receiver 205 and a second transmitter 206.

The first communication unit 203 communicates with the vehicle communication device 100. The first receiver 201 of the first communication unit 203 receives the vehicle identification information that identifies the vehicle. The first transmitter 202 of the first communication unit 203 transmits the parking space identification information that identifies the parking space.

Receiving of the vehicle identification information and the transmitting of the parking space identification information may be executed in any order.

The second communication unit 207 communicates with the parking lot management server 400 provided outside of the parking lot communication device 200. The parking lot management server 400 corresponds to an information processing device in the present disclosure. Specifically, the second transmitter 206 of the second communication unit 207 transmits the vehicle identification information received by the first receiver 201 and the parking space identification information to the parking lot management server 400.

The controller 204 controls the first communication unit 203 and the second communication unit 207, and manages the information transmitted from or received by the first communication unit 203 and the second communication unit 207. The controller 204 stores, in the storage 208, or reads out, from the storage 208, the information transmitted from or received by the first communication unit 203 and the second communication unit 207.

The storage 208 stores information necessary for the parking lot communication device. For example, the parking space identification information that identifies the parking space where the parking lot communication device 200 is installed. The parking space identification information is read out from the controller 204, and transmitted by the first transmitter 202 and the second transmitter 206.

When the presence detection sensor 210 detects that a vehicle presents in the parking space where the sensor is installed, the presence detection sensor 210 transmits a vehicle detection signal to the controller 204 of the parking lot communication device 200. In response to receiving of the vehicle detection signal, the controller 204 receives the vehicle identification information from the vehicle communication device 100 via the first communication unit 203, and controls the first communication unit 203 to transmit the parking space identification information to the vehicle communication device 100. The controller 204 controls the second communication unit 207 to transmit, to the parking lot management server 400, the received vehicle identification information, the parking space identification information read out from the storage unit 208, and parking space availability information indicating available state or unavailable state of the parking space. The parking space availability information indicating available state of the parking space is also referred to as available state information, and the parking space availability information indicating unavailable state of the parking space is also referred to as unavailable state information.

In the present embodiment, the presence detection sensor 210 is installed separate from the parking lot communication device 200. Alternatively, the presence detection sensor 210 may be integrated with the parking lot communication device 200 as one device.

The presence detection sensor 210 may include a magnetic field sensor, an infrared sensor or the like.

(First Communication Unit)

A short-range wireless communication device may be used as the first communication unit 103 of the vehicle communication device 100 and the first communication unit 203 of the parking lot communication device 200.

The short-range wireless communication in the present disclosure refers to a wireless communication that covers a range of about 20 meters or less. For example, ZigBee (registered trademark), Bluetooth (registered trademark), FeliCa (registered trademark), NFC (Near Field Communication), radio frequency identifier (RFID), etc. may be employed as the short-range communication in the present disclosure.

By employing the short-range wireless communication, the vehicle communication device 100 communicates only with the parking lot communication device 200 installed in the parking space where the vehicle is parked. Thus, radio wave interference with the parking lot communication device 200 installed in the adjacent parking space can be prevented. The parking lot communication device 200 can be driven with low power. Thus, the parking lot communication device 200 can be properly installed in a parking lot which has limited power supply system.

As the first communication unit 103 of the vehicle communication device 100 and the first communication unit 203 of the parking lot communication device 200, short-range wireless communication, such as smart entry (registered trademark) or smart key (registered trademark) may be employed. In a case where the smart entry or smart key is employed, the first transmitter 102 of the vehicle communication device 100 transmits the vehicle identification information using low frequency wave (LF), and the first receiver 201 of the parking lot communication device 200 receives the vehicle identification information using low frequency wave. In the case where the smart entry or smart key is employed, the first transmitter 202 of the parking lot communication device 200 transmits the parking space identification information using ultra high frequency wave (RF), and the first receiver 101 of the vehicle communication device 100 receives the parking space identification information using ultra high frequency wave. The low frequency wave has a frequency of, for example, 30 kHz to 300 kHz. The ultra high frequency wave has a frequency of, for example, 300 MHz to 3 GHz.

By employing the communication method used in the smart entry (registered trademark) or the like, it is possible to use a communication device already installed to the vehicle. Due to the radio wave characteristics of the LF wave, transmission of the wave can be limited to the parking space where the vehicle is parked. Thus, erroneous transmission to the parking lot communication device 200 provided in another parking space can be prevented.

(Second Communication Unit)

A low power consumption wide area (LPWA) wireless communication device may be used as the second communication unit 107 of the vehicle communication device 100 and the second communication unit 207 of the parking lot communication device 200. For example, the low power wide area (LPWA) wireless communication may include enhanced Machine Type Communication (eMTC), Narrow Band Internet of Things (NB-loT) in Third Generation Partnership Project (3GPP), SIGFOX, Long Range Wide Area Network (LoRaWAN) or the like.

The low power consumption wide area wireless (LPWA) communication method of the present disclosure is a general term for wireless systems having low power consumption and a wide coverage area, and the communication method is not limited under a condition that wide area communication is carried out under low power consumption.

In a case where the low power consumption wide area wireless communication is applied to the parking lot communication device 200, the communication device can be driven with low power consumption. Thus, this communication method is proper to a use installed in the parking lot where the power supply system is limited.

The second communication unit 107 of the vehicle communication device 100 and the second communication unit 207 of the parking lot communication device 200 may employ Long Term Evolution (LTE), 4G, or 5G communication method instead of the low power consumption wide area (LPWA) wireless communication. For example, LTE communication may be used in the second communication unit 107 of the vehicle communication device 100 which has a secured power supply. For example, low power consumption wide area communication may be used in the second communication unit 207 of the parking lot communication device 200 which has a limited power supply.

Transmission time interval of information that is periodically transmitted to the parking lot management server 400 may be set different according to a time slot. The information that is periodically transmitted to the parking lot management server 400 includes the parking space availability information, synchronization signal or the like. For example, the transmission time interval may be set long in a midnight time slot in which an empty rate of the parking lot is statistically high. For example, the transmission time interval may be set short in a day time slot in which a full rate of the parking lot is high. For detecting the time slot, a clock may be provided in the parking lot communication device 200, and the time slot is detected based on an output of the clock. Alternatively, the parking lot management server 400 may transmit time information to the parking lot communication device 200, and the time slot may be detected based on the time information transmitted from the parking lot management server 400.

Transmission time interval of information that is periodically transmitted to the parking lot management server 400 may be set different according to a detection result of available state in the parking lot. For example, the detection result of available state may include empty rate of the parking lot or a quantity of empty parking spaces. The information that is periodically transmitted to the parking lot management server 400 includes the parking space availability information, synchronization signal or the like. For example, the transmission time interval may be set short in response to the empty rate or the quantity of the empty parking spaces being equal to or lower than a predetermined level. For example, the transmission time interval may be set long in response to the empty rate or the quantity of the empty parking spaces being equal to or higher than a predetermined level. The transmission time interval may be set to continuously change according to the empty rate of the parking lot. The empty rate or the quantity of empty parking spaces may be reported from each parking lot communication device 200 to the parking lot management server 400. Then, the parking lot management server 400 can instruct each parking lot communication device 200 to change the transmission time interval.

By changing the transmission time interval as described above, battery consumption of the parking lot communication device 200 employing the low power consumption wide area wireless communication can be suppressed. As a result, a battery replacement cycle can be lengthened.

(Driver Management Server)

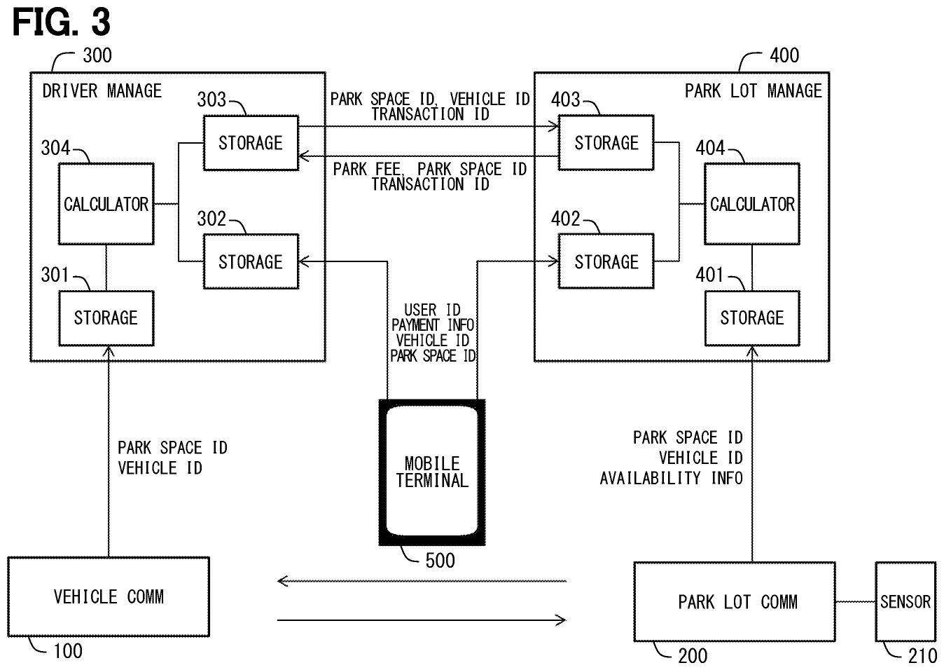

Details of the driver management server 300 similar in each embodiment of the present disclosure will be described with reference to FIG. 3.

The driver management server 300 includes a first storage 301, a second storage 302, a third storage 303, and a calculator 304. In FIG. 3, a communication unit that transmits/receives information to/from the outside of the driver management server 300 is not shown because each storage 301, 302, 303 has communication function.

The first storage 301 stores the parking space identification information (corresponding to first parking space identification information in the present disclosure) received from the vehicle communication device 100, and stores the vehicle identification information (corresponding to first vehicle identification information in the present disclosure) received from the vehicle communication device 100.

The second storage 302 stores user identification information acquired from the user's mobile information terminal 500, payment information of the user correlated to the user identification information, parking space identification information (corresponding to second parking space identification information in the present disclosure) correlated to the parking space which is permitted to the user, and vehicle identification information (corresponding to second vehicle identification information in the present disclosure) correlated to the user identification information.

Acquiring the user identification information from the user's mobile information terminal includes acquiring the information input by the user on the mobile information terminal after the user accesses the information processing device using the mobile information terminal. Alternatively, acquiring the user identification information from the user's mobile information terminal includes acquiring the user identification information from another information processing device in a case where the user inputs the information on the mobile information terminal after accessing another information processing device using the mobile information terminal.

The third storage 303 stores parking fee, the parking space identification information, and transaction ID which are received from the parking lot management server 400.

The calculator 304 controls the first storage 301, the second storage 302, and the third storage 303 to read and write information, and performs necessary calculation based on the related information.

(Parking Lot Management Server)

Details of the parking lot management server 400 similar in each embodiment of the present disclosure will be described with reference to FIG. 3.

The parking lot management server 400 includes a first storage 401, a second storage 402, a third storage 403, and a calculator 404. In FIG. 3, a communication unit that transmits/receives information to/from the outside of the parking lot management server 400 is not shown because each storage 401, 402, 403 has communication function.

The first storage 401 stores the parking space identification information (corresponding to the first parking space identification information in the present disclosure) received from the parking lot communication device 200, and stores the vehicle identification information (corresponding to the first vehicle identification information in the present disclosure) received from the parking lot communication device 200. The first storage 401 stores the parking space availability information of each parking space transmitted from each parking lot communication device 200.

The second storage 402 stores user identification information acquired from the user's mobile information terminal 500, payment information of the user correlated to the user identification information, parking space identification information (corresponding to the second parking space identification information in the present disclosure) correlated to the parking space which is permitted to the user, and vehicle identification information (corresponding to the second vehicle identification information in the present disclosure) correlated to the user identification information.

The third storage 403 stores the vehicle identification information, the parking space identification information, and the transaction ID which are received from the driver management server 300.

The calculator 404 controls the first storage 401, the second storage 402, and the third storage 403 to read and write information, and performs necessary calculation based on the related information.

### First Embodiment

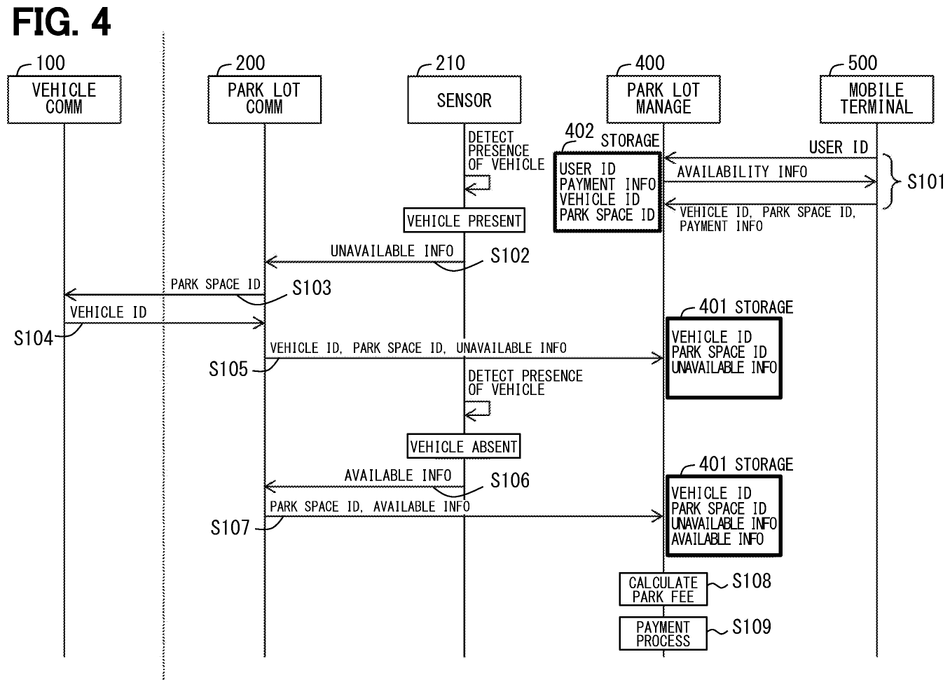

The following will describe an operation of the parking lot management system according to a first embodiment of the present disclosure with reference to FIG. 4. The parking lot management system of the first embodiment mainly uses the parking lot communication device 200 and the parking lot management server 400. The following will describe the parking lot management system including the parking lot communication device 200 and the parking lot management server 400.

The user accesses the parking lot management server 400 using the mobile information terminal 500, and makes a parking reservation in S101. Specifically, the user logs in an application installed in the mobile information terminal 500 using the user identification information (also referred to as user ID), and makes reservation of the parking lot with reference to the parking space availability information of each parking space and reservation state of each parking space which are transmitted from the parking lot management server 400. The user inputs, on the mobile information terminal, a reservation parking space, date and time of parking start, date and time of parking end, vehicle identification information, and payment information. Then, the information input to the mobile information terminal is transmitted to the parking lot management server 400. As a result, the user identification information, the payment information, the vehicle identification information, and the parking space identification information, which are received from the mobile information terminal 500, are stored in the second storage 402 of the parking lot management server 400.

In response to the user parks the vehicle in the reserved parking space, the presence detection sensor 210 detects the presence of the vehicle and transmits, to the parking lot communication device 200, the unavailable state information of the parking space in S102. In response to the parking lot communication device 200 receiving the unavailable state information of the parking space, the parking lot communication device 200 reads out, from the storage 208, the parking space identification information and transmits the read-out parking space identification information to the vehicle communication device 100 in S103.

In response to the receiving of the parking space identification information, the vehicle communication device 100 reads out, from the storage 108, the vehicle identification information, and transmits the read-out vehicle identification information to the parking lot communication device 200 in S104. The parking lot communication device 200 transmits, to the parking lot management server 400, the received vehicle identification information together with the parking space identification information and the unavailable state information of the parking space in S105. As a result, the parking lot management server 400 stores, in the first storage 401, the vehicle identification information, the parking space identification information, and the unavailable state information of the parking space, which are transmitted from the parking lot communication device 200.

In response to the vehicle exiting from the reserved parking space, that is absence of the vehicle in the parking space, the presence detection sensor 210 transmits, to the parking lot communication device 200, the available state information of the parking space in S106. In response to receiving of the available state information of the parking space, the parking lot communication device 200 transmits, to the parking lot management server 400, the parking space identification information and the available state information of the parking space in S107. As a result, the parking lot management server 400 stores, in the first storage 401, the available state information of the parking space transmitted from the parking lot communication device 200.

In response to the storing of the unavailable state information and available state information of the parking space in the first storage 401, the calculator 404 of the parking lot management server 400 calculates the parking fee in S108. As an example of parking fee calculation, the parking period is calculated with reference to a time point when the unavailable state information is recorded in the first storage 401 and a time point when the available state information is recorded in the first storage 401. Then, the parking fee is calculated by multiplying the unit price per hour with the calculated parking period. The parking fee may also be calculated based on the reservation date and time of parking start and reservation date and time of parking end, which are stored in the second storage 402. Alternatively, the calculation method of the parking fee may be changed according to a determination result of determination whether the parking period calculated according to the time points stored in the first storage 401 is included in a range of the reservation date and time of parking start to the reservation date and time of parking end stored in the second storage 402.

The calculator 404 of the parking lot management server 400 executes the following payment process in S109.

The parking lot management server 400 reads out, from the second storage 402, the parking space identification information (corresponding to second parking space identification information in the present disclosure), and reads out, from the first storage 401, the parking space identification information (corresponding to the first parking space identification information). In response to the parking space identification information read out from the first storage 401 being identical to the parking space identification information read out from the second storage 402, that is, the parking space identified by the parking space identification information read out from the first storage 401 being identical to the parking space identified by the parking space identification information read out from the second storage 402, the parking lot management server 400 executes the payment process with reference to the user identification information and the payment information which are stored in the second storage 402.

Executing the payment process includes executing the payment process using the information processing device configuring the parking lot management system. Alternatively, executing the payment process includes transmitting payment information to another information processing device that executes the payment process within the parking lot management system.

With above-described configuration, the payment process is executed in a case where the parking space input or designated in the reservation is identical to the parking space actually used by the user. Thus, a matching of the parking space reservation with the actual use of the parking space can be secured in the payment process.

The following will describe another example of payment process of S109.

The parking lot management server 400 reads out, from the second storage 402, the parking space identification information (corresponding to second parking space identification information in the present disclosure) and vehicle identification information (corresponding to second vehicle identification information in the present disclosure). The parking lot management server 400 reads out, from the first storage 401, the parking space identification information (corresponding to the first parking space identification information) and the vehicle identification information (corresponding to the second vehicle identification information in the present disclosure). In response to the parking space identification information and the vehicle identification information read out from the first storage 401 being identical to the parking space identification information and the vehicle identification information read out from the second storage 402, respectively, that is, the parking space identified by the parking space identification information read out from the first storage 401 being identical to the parking space identified by the parking space identification information read out from the second storage 402 and the vehicle identified by the vehicle identification information read out from the first storage 401 being identical to the vehicle identified by the vehicle identification information read out from the second storage 402, the parking lot management server 400 executes the payment process with reference to the user identification information and the payment information which are stored in the second storage 402.

With above-described configuration, the payment process is executed in a case where the vehicle input in the reservation is identical to the vehicle actually parked in the parking space. Thus, a matching of the parking space reservation with the actual use of the parking space can be secured in the payment process. In a case where a user different from the user who made the reservation parks a vehicle in the reserved parking space, the parking fee is calculated by referring a database of the driver management server 300 that stores the vehicle identification information of the parked vehicle and the correlated user identification information. Thus, the user who actually parks the vehicle in the parking space is required to pay the parking fee.

### Second Embodiment

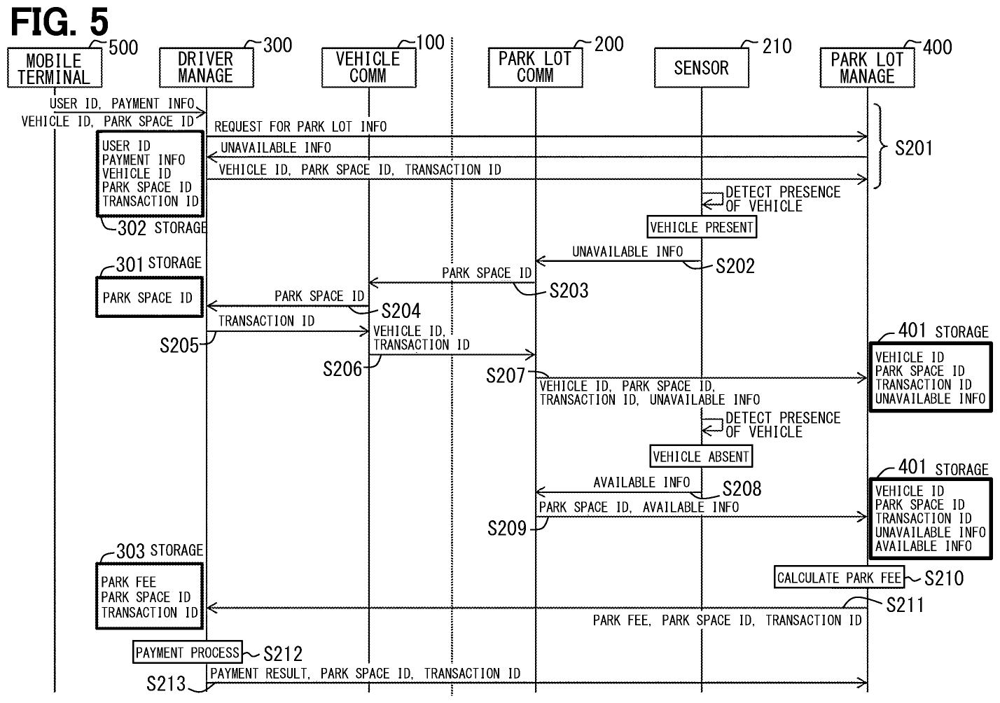

The following will describe an operation of the parking lot management system according to a second embodiment of the present disclosure with reference to FIG. 5. The parking lot management system of the first embodiment mainly uses the vehicle communication device 100 and the driver management server 300. The following will describe the parking lot management system including the vehicle communication device 100 and the driver management server 300.

The user accesses the parking lot management server 400 via the driver management server 300 using the mobile information terminal 500, and makes a parking reservation in S201. Specifically, the user logs in an application installed in the mobile information terminal 500 by inputting the user identification information, and the driver management server 300 requests the parking lot management server 400 for the parking lot information. The user makes reservation of the parking lot with reference to the parking space availability information of each parking space and reservation state of each parking space which are transmitted from the parking lot management server 400 in response to the request from the driver management server 300. The user inputs, on the mobile information terminal, a reservation parking space, date and time of parking start, date and time of parking end, vehicle identification information, payment information, and transaction ID indicating the current reservation. Then, the information input to the mobile information terminal is transmitted to the driver management server 300. As a result, the driver management server 300 stores, in the second storage 302, the user identification information, the payment information, the vehicle identification information, the parking space identification information, and the transaction ID, which are transmitted from the mobile information terminal 500.

In response to the user parks the vehicle in the reserved parking space, the presence detection sensor 210 detects the presence of the vehicle and transmits, to the parking lot communication device 200, the unavailable state information of the parking space in S202. In response to the parking lot communication device 200 receiving the unavailable state information of the parking space, the parking lot communication device 200 reads out, from the storage 208, the parking space identification information and transmits the read-out parking space identification information to the vehicle communication device 100 in S203.

The vehicle communication device 100 transmits the received parking space identification information to the driver management server 300 in S204. The driver management server reads out, from the second storage 302, the transaction ID correlated to the parking space identification information, and transmits the transaction ID to the vehicle communication device 100 in S205. The driver management server 300 stores the parking space identification information transmitted from the vehicle communication device 100 in the first storage 301. The vehicle communication device 100 reads out, from the storage 108, the vehicle identification information, then transmits, to the parking lot communication device 200, the readout vehicle identification information together with the transaction ID in S206. The parking lot communication device 200 transmits, to the parking lot management server 400, the received transaction ID and the vehicle identification information, together with the parking space identification information and the unavailable state information of the parking space in S207. As a result, the parking lot management server 400 stores, in the first storage 401, the vehicle identification information, the parking space identification information, the transaction ID, and the unavailable state information of the parking space, which are transmitted from the parking lot communication device 200.

In response to the vehicle exiting from the reserved parking space, the presence detection sensor 210 transmits, to the parking lot communication device 200, the available state information of the parking space in S208. In response to receiving of the available state information of the parking space, the parking lot communication device 200 transmits, to the parking lot management server 400, the parking space identification information and the available state information of the parking space in S209. As a result, the parking lot management server 400 stores, in the first storage 401, the available state information of the parking space transmitted from the parking lot communication device 200.

In response to the storing of the unavailable state information and the available state information of the parking space in the first storage 401, the calculator 404 of the parking lot management server 400 calculates the parking fee in S210. The method of calculating the parking fee is the same as that of the first embodiment.

The parking lot management server 400 transmits, to the driver management server 300, the calculated parking fee, the parking space identification information, and the transaction ID in S211.

The driver management server 300 stores, in the third storage 303, the parking fee, the parking space identification information, and the transaction ID, which are transmitted from the parking lot management server 400.

The calculator 304 of the driver management server 300 executes the following payment process in S212.

The driver management server 300 reads out, from the second storage 302, the parking space identification information (corresponding to the second parking space identification information in the present disclosure), and reads out, from the first storage 301 or from the third storage 303, the parking space identification information (corresponding to the first parking space identification information). In response to the parking space identification information read out from the first storage 301 being identical to the parking space identification information read out from the second storage 302 or from the third storage 303, that is, the parking space identified by the parking space identification information read out from the first storage 301 being identical to the parking space identified by the parking space identification information read out from the second storage 302 or from the third storage 303, the driver management server 300 executes the payment process with reference to the user identification information and the payment information which are stored in the second storage 302.

The driver management server 300 transmits, to the parking lot management server 400, the calculated parking fee, the transaction ID, and the parking space identification information in S213.

With above-described configuration, the payment process is executed in a case where the parking space input or designated in the reservation is identical to the parking space actually used by the user. Thus, a matching of the parking space reservation with the actual use of the parking space can be secured in the payment process.

Instead of the mobile information terminal 500, the user may input information using a navigation system equipped to a vehicle. The user may also execute payment process or confirm the payment process using the navigation system equipped to the vehicle.

Before reserving the parking space in S201, the driver management server 300 may execute a biometric identification using biometric information. The driver management server 300 may be configured to execute the payment process for the user who clears the biometric identification.

In a case where a rental car or a shared car is used as the vehicle instead of the user's own vehicle, vehicle information and user information may be transmitted from the server of the rental/shared car operator to the driver management server 300 in advance. The driver management server 300 compares the information transmitted from the server of the rental/shared car operator with the information, which is input to the user's mobile information terminal 500 by the user and then transmitted to the driver management server 300. In response to the information transmitted from the server of the rental/shared car operator being identical to the information transmitted from the user's mobile information terminal 500, that is, user authentication being succeeded, the driver management server 300 proceeds to reservation and payment process.

### Other Embodiments

In the above embodiments, it is assumed that the vehicle communication device 100 and the parking lot communication device 200 communicate with one another in both directions. In the present embodiment, a vehicle communication device 600 does not directly communicate with a parking lot communication device 700. The vehicle communication device 600 is configured to receive, from the parking lot management server 400, the information which is transmitted and received between the parking lot communication device 700 and the parking lot management server 400. The driver management server 300 and the parking lot management server 400 have configurations similar to those of the first embodiment.

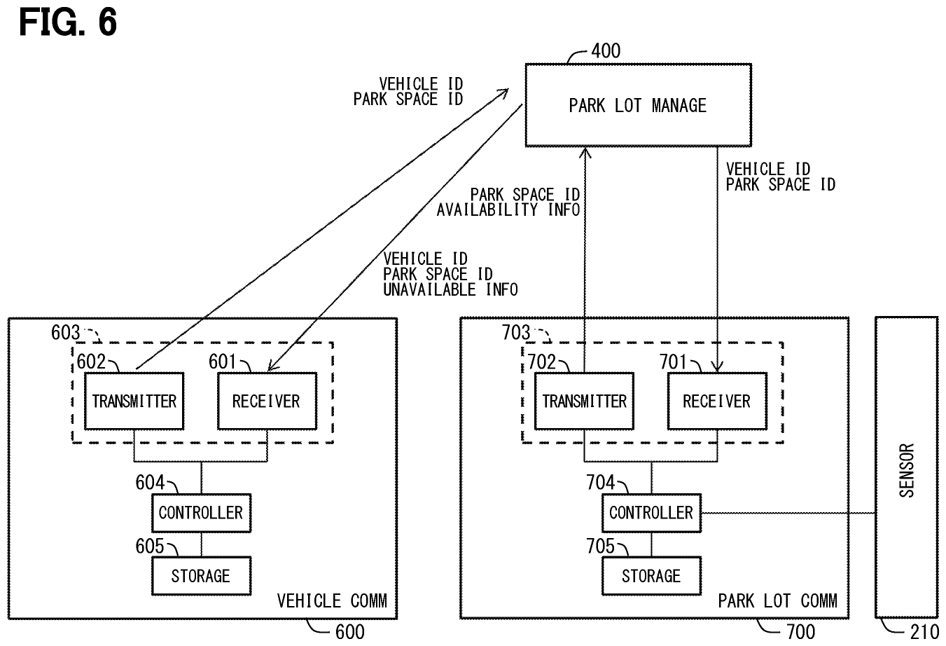

The following will describe the vehicle communication device 600 and the parking lot communication device 700 according to the present embodiment with reference to FIG. 6.

The vehicle communication device 600 includes a communication unit 603, a controller 604, and a storage 605. The communication unit 603 includes a receiver 601 and a transmitter 602. Comparing with the vehicle communication device 100 shown in FIG. 2, the vehicle communication device 600 according to the present disclosure does not include the first communication unit 103 that communicates with the parking lot communication device 200. The communication unit 603 employs low power consumption wide area wireless (LPWA) communication. Alternatively, the communication unit 603 may employ LTE communication.

The parking lot communication device 700 includes a communication unit 703, a controller 704, and a storage 705. The communication unit 703 includes a receiver 701 and a transmitter 702. Comparing with the parking lot communication device 200 shown in FIG. 2, the parking lot communication device 700 according to the present disclosure does not include the first communication unit 203 that communicates with the vehicle communication device 100. The communication unit 703 employs low power consumption wide area wireless (LPWA) communication.

The receiver 701 of the parking lot communication device 700 receives the vehicle identification information and the parking space identification information, which are transmitted from the parking lot management server 400. The vehicle identification information and the parking space identification information are transmitted from the mobile information terminal 500 to the parking lot management server 400 in response to the user reserving the parking space using the mobile information terminal 500.

The transmitter 702 of the parking lot communication device 700 transmits, to the parking lot management server 400, the parking space identification information and the parking space availability information. The parking lot communication device 700 generates the parking space availability information based on a vehicle detection signal which is transmitted from the presence detection sensor 210. The presence detection sensor 210 transmits the vehicle detection signal in response to a detection of the vehicle parked in the parking space.

The receiver 601 of the vehicle communication device 600 receives, from the parking lot management server 400, the information which is transmitted and received between the parking lot management server 400 and the parking lot communication device 700. Specifically, the receiver 601 of the vehicle communication device 600 receives, from the parking lot management server 400, the vehicle identification information, the parking space identification information, and the unavailable state information of the parking space, which are transmitted and received between the parking lot management server 400 and the parking lot communication device 700. The transmitter 602 of the vehicle communication device 600 transmits, to the parking lot management server 400, the vehicle identification information and the parking space identification information.

Other configurations of the vehicle communication device 600 and the parking lot communication device 700 of the present embodiment are similar to the configurations of the vehicle communication device 100 and the parking lot communication device 200 shown in FIG. 2.

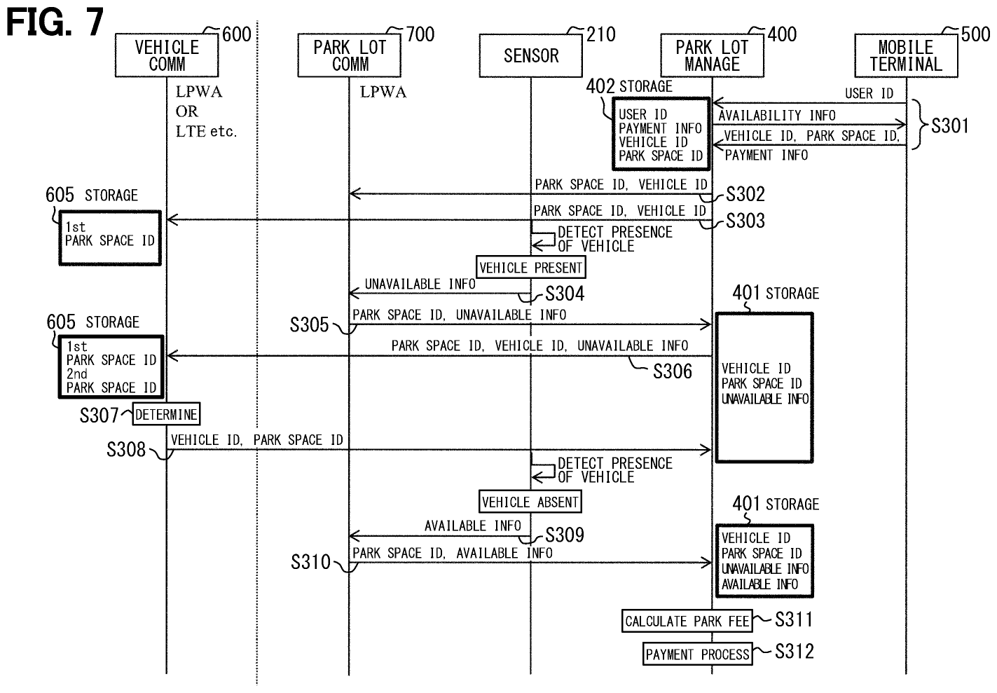

The following will describe an operation of the parking lot management system according to the present embodiment with reference to FIG. 7. The description of the process that is similar to the first embodiment will be omitted.

The user accesses the parking lot management server 400 using the mobile information terminal 500, and makes a reservation of the parking space in S301. The process executed in S301 is similar to S101 of the first embodiment. As a result, the user identification information, the payment information, the vehicle identification information, and the parking space identification information, which are received from the mobile information terminal 500, are stored in the second storage 402 of the parking lot management server 400.

The parking lot management server 400 transmits the vehicle identification information and the parking space identification information, which are stored in the second storage 402, to the parking lot communication device 700 in S302. The parking lot management server 400 transmits the vehicle identification information and the parking space identification information (corresponding to the first parking space identification information in the present disclosure), which are stored in the second storage 402, to the vehicle communication device 600 in S303. The vehicle communication device 600, which is the transmission destination, can be specified based on the vehicle identification information.

The vehicle communication device 600 receives the vehicle identification information and the parking space identification information, which are transmitted from the parking lot management server 400. The vehicle communication device 600 stores the received parking space identification information in the storage 605 as the first parking space identification information.

In response to the user parks the vehicle in the reserved parking space, the presence detection sensor 210 detects the presence of the vehicle and transmits, to the parking lot communication device 700, the unavailable state information of the parking space in S304. After receiving the unavailable state information of the parking space, the parking lot communication device 700 transmits, to the parking lot management server 400, the received unavailable state information of the parking space together with parking space identification information indicating the parking space to which the parking lot communication device 700 is installed in S305.

The parking lot management server 400 receives, from the parking lot communication device 700, the unavailable state information of the parking space and the parking space identification information. The parking lot management server 400, with reference to the vehicle identification information stored in the second storage 402 correlated to the parking space identification information, transmits, to the vehicle communication device 600, the unavailable state information of the parking space and the parking space identification information (corresponding to the second parking space identification information in the present disclosure) which are transmitted from the parking lot communication device 700, together with the vehicle identification information stored in the second storage 402 in S306. The vehicle communication device 600 stores the received parking space identification information in the storage 605 as the second parking space identification information.

The controller 604 of the vehicle communication device 600 compares the first parking space identification information received in S303 with the second parking space identification information received in S306. The controller 604 determines whether the first parking space identification information is identical to the second parking space identification information, that is, the controller 604 determines whether own vehicle is parked in the parking space reserved using the mobile information terminal 500 in S307. The parking space identification information of the reserved parking space may be transmitted from the mobile information terminal 500 that is used to reserve the parking space. Alternatively, the parking space identification information received in S303 may be used. The user determines whether own vehicle is parked in the reserved parking space, and inputs the result to the vehicle communication device 600.

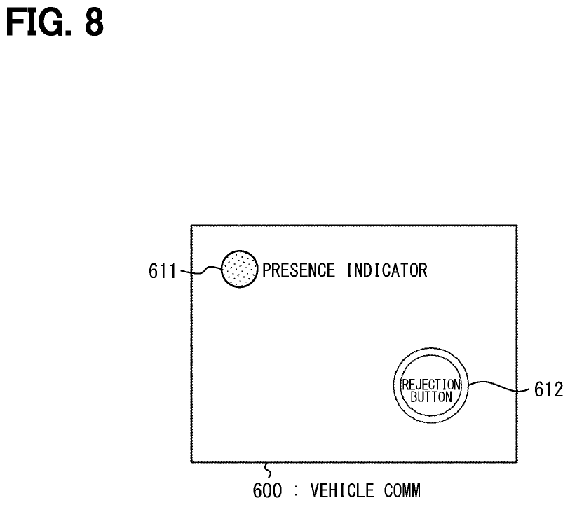

FIG. 8 is an example of a vehicle communication device 600 that enables an input from a user. In addition to the configuration shown in FIG. 6, the vehicle communication device 600 is further provided with a presence indicator 611 and a rejection button 612.

In response to the first parking space identification information received in S303 identical to the second parking space identification information received in S306, the presence indicator 611 indicates a presence of the vehicle according to the unavailable state information of the parking space which is correlated to the second parking space identification information received in S306. For example, the presence indicator 611 displays a red-colored signal in response to the reception of the unavailable state information of the parking space. The presence indication may display a blue-colored signal except the case where the unavailable state information of the parking space is received.

In response to the presence indicator 611 displays the red-colored signal, the user determines whether the vehicle has been parked in the reserved parking space. In a case where the user has parked the vehicle in the reserved parking space, the user does not push the rejection button 612. In this case, the following process is executed in S308. In a case where the user has parked the vehicle in a different parking space from the reserved parking space, it can be determined that another vehicle is parked in the reserved parking space. In this case, the user pushes the rejection button 612. In response to the pushing of the rejection button 612, the vehicle communication device 600 transmits, to the parking lot management server 400, a signal that reports another vehicle is parked in the reserved parking space.

Returning to FIG. 7, the vehicle communication device 600 transmits, to the parking lot management server 400, the second parking space identification information stored in the storage 605 and vehicle identification information of the vehicle to which the vehicle communication device 600 is installed in S308. The parking lot management server 400 stores, in the first storage 401, the unavailable state information of the parking space and the parking space identification information which are received in S305, together with the vehicle identification information received in S308.

The process executed in S309 to S312 after use of the parking space are similar to the process executed in S106 to S109 in FIG. 2, and the detailed description will be omitted.

According to the present embodiment, the vehicle communication device 600 does not directly communicate with the parking lot communication device 700. Thus, the configurations of the vehicle communication device 600 and the parking lot communication device 700 can be simplified, and thereby reducing the manufacturing cost of the devices.

The configurations and operations of the vehicle communication device, the parking lot communication device, the parking lot management system according to each embodiment of the present disclosure have been described above.

Terms used in the description of each embodiment are examples and may be replaced with synonymous terms or terms having a synonymous function.

The block diagram used in the description of each embodiment is a diagram in which the configurations of devices and the like are classified and organized by function. In the block diagram, each functional block may be provided by a single physical component or device. Alternatively, each functional block may be provided by several physical components or devices. Alternatively, several functional blocks may be provided by a single physical component or device. These functional blocks may be provided by any combination of hardware or software. Further, since the functions are shown, the block diagram can be understood as disclosure of the method and the program that implements the method.

Order of functional blocks that can be grasped as processing, a sequence, and a method described in relation to each embodiment may be changed unless some restriction is imposed, for example, a result from one step is utilized at another step.

The terms of “first” and “second” used in the description of each embodiment and the present disclosure are for discriminating two or more configurations and methods of the same kind and do not limit order or superiority or inferiority.

As the implementation example of the vehicle communication device, an electronic control unit (ECU) or semiconductor circuit is described in the present disclosure. Alternatively, a mobile phone, a smartphone, a tablet, a vehicle navigation system may be employed as the implementation example of the vehicle communication device.

The present disclosure is implemented not only by dedicated hardware having a configuration and a function described in relation to each embodiment. The present disclosure can also be implemented as a combination of a program for implementing the present disclosure, recorded on such a recording medium as memory and a hard disk and general-purpose hardware including dedicated or general-purpose CPU, memory, or the like, capable of executing the program.

A programs stored in a dedicated or general-purpose hardware storage medium (external storage device (hard disk, USB memory, CD/BD, etc.), or internal storage (RAM, ROM, etc.) may be provided to a dedicated or general-purpose hardware from a server via a communication line with or without using a storage medium. Consequently, when the program is upgraded, the latest function is always provided. A special-purpose or general-purpose hardware storage medium and an internal storage are examples of a computer-readable non-transitory tangible storage medium.

The vehicle communication device, the parking lot communication device, and the parking lot management system described in the present disclosure are used for managing and payment about the parking lot. Alternatively, the vehicle communication device, the parking lot communication device, and the parking lot management system in the present disclosure may be used for managing and payment within a system where a vehicle side is separate from a road side, such as a drive through.

What is claimed is:

1. A parking lot management system comprising:
a vehicle communication device equipped to a vehicle; and
an information processing device positioned outside of the vehicle,
wherein
the vehicle communication device includes:
a first communication unit receiving first parking space identification information from a parking lot communication device and transmitting vehicle identification information used for identifying the vehicle to the parking lot communication device, the parking lot communication device being installed to each parking space in a parking lot; and
a second communication unit transmitting, to the information processing device, the first parking space identification information that is received and the vehicle identification information, and
the information processing device includes:
a first storage storing the first parking space identification information and the vehicle identification information which are transmitted from the vehicle communication device;
a second storage storing user identification information acquired in response to a user inputting a request to use the parking lot, payment information which is correlated to the user identification information, and second parking space identification information of a parking space which is allowed to the user for vehicle parking;
a third storage storing the first parking space identification information transmitted from a parking lot management server that communicates with the parking lot communication device; and
a calculator calculating parking fee according to the payment information in response to the parking space specified by the first parking space identification information being identical to the parking space specified by the second parking space identification information.

2. A parking lot management system comprising:
a parking lot communication device installed to each parking space of a parking lot; and
an information processing device positioned outside of the parking lot communication device,
wherein
the parking lot communication device includes:
a first communication unit receiving, from a vehicle communication device equipped to a vehicle, vehicle identification information used for identifying the vehicle, and the first communication unit transmitting, to the vehicle communication device, first parking space identification information used for identifying a parking space to which the parking lot communication device is installed; and
a second communication unit transmitting the vehicle identification information that is received and the first parking space identification information to the information processing device, and
the information processing device includes:
a first storage storing the vehicle identification information and the first parking space identification information which are transmitted from the parking lot communication device;
a second storage storing user identification information acquired in response to a user inputting a request to use the parking lot, payment information which is correlated to the user identification information, and second parking space identification information of a parking space which is allowed to the user for vehicle parking; and
a calculator calculating parking fee according to the payment information in response to the parking space specified by the first parking space identification information being identical to the parking space specified by the second parking space identification information.

3. An information processing device that communicates with a vehicle communication device equipped to a vehicle, wherein
the vehicle communication device includes:
a first communication unit receiving first parking space identification information from a parking lot communication device and transmitting vehicle identification information used for identifying the vehicle to the parking lot communication device, the parking lot communication device being installed to each parking space in a parking lot; and
a second communication unit transmitting, to the information processing device positioned outside of the vehicle, the first parking space identification information that is received and the vehicle identification information,
the information processing device comprising:
a first storage storing the first parking space identification information and the vehicle identification information which are transmitted from the vehicle communication device;
a second storage storing user identification information acquired in response to a user inputting a request to use the parking lot, payment information which is correlated to the user identification information, and second parking space identification information of a parking space which is allowed to the user for vehicle parking;
a third storage storing the first parking space identification information transmitted from a parking lot management server that communicates with the parking lot communication device; and
a calculator calculating parking fee according to the payment information in response to the parking space specified by the first parking space identification information being identical to the parking space specified by the second parking space identification information.

4. An information processing device which communicates with a parking lot communication device installed to each parking space of a parking lot, wherein
the parking lot communication device includes:
a first communication unit receiving, from a vehicle communication device equipped to a vehicle, vehicle identification information used for identifying the vehicle, and the first communication unit transmitting, to the vehicle communication device, first parking space identification information used for identifying a parking space to which the parking lot communication device is installed; and
a second communication unit transmitting the vehicle identification information that is received and the first parking space identification information to the information processing device positioned outside of the parking lot communication device,
the information processing device comprising:
a first storage storing the vehicle identification information and the first parking space identification information which are transmitted from the parking lot communication device;
a second storage storing user identification information acquired in response to a user inputting a request to use the parking lot, payment information which is correlated to the user identification information, and second parking space identification information of a parking space which is allowed to the user for vehicle parking; and
a calculator calculating parking fee according to the payment information in response to the parking space specified by the first parking space identification information being identical to the parking space specified by the second parking space identification information.

5. The information processing device according to claim 4, wherein
the vehicle identification information transmitted from the parking lot communication device is defined as first vehicle identification information,
the second storage further stores second vehicle identification information which is correlated to the user identification information, and
the calculator calculates the parking fee in response to (i) the parking space specified by the first parking space identification information being identical to the parking space specified by the second parking space identification information and (ii) the vehicle specified by the first vehicle identification information being identical to the vehicle specified by the second vehicle identification information.

6. A parking lot management program product stored in a non-transitory computer readable medium, the program product comprising instructions to be executed by a processor included in an information processing device that communicates with a vehicle communication device equipped to a vehicle, wherein
the vehicle communication device includes:
a first communication unit receiving first parking space identification information from a parking lot communication device and transmitting vehicle identification information used for identifying the vehicle to the parking lot communication device, the parking lot communication device being installed to each parking space in a parking lot; and
a second communication unit transmitting, to the information processing device positioned outside of the vehicle, the first parking space identification information that is received and the vehicle identification information,
the instructions comprising:
storing the first parking space identification information and the vehicle identification information which are transmitted from the vehicle communication device;
storing user identification information acquired in response to a user inputting a request to use the parking lot, payment information which is correlated to the user identification information, and second parking space identification information of a parking space which is allowed to the user for vehicle parking;
storing the first parking space identification information transmitted from a parking lot management server that communicates with the parking lot communication device; and
calculating parking fee according to the payment information in response to the parking space specified by the first parking space identification information being identical to the parking space specified by the second parking space identification information.

7. A parking lot management program product stored in a non-transitory computer readable medium, the program product comprising instructions to be executed by a processor included in an information processing device that communicates with a parking lot communication device installed to each parking space of a parking lot, wherein
the parking lot communication device includes:
a first communication unit receiving, from a vehicle communication device equipped to a vehicle, vehicle identification information used for identifying the vehicle, and the first communication unit transmitting, to the vehicle communication device, first parking space identification information used for identifying a parking space to which the parking lot communication device is installed; and
a second communication unit transmitting the vehicle identification information that is received and the first parking space identification information to the information processing device positioned outside of the parking lot communication device,
the instructions comprising:
storing the vehicle identification information and the first parking space identification information which are transmitted from the parking lot communication device;
storing user identification information acquired in response to a user inputting a request to use the parking lot, payment information which is correlated to the user identification information, and second parking space identification information of a parking space which is allowed to the user for vehicle parking; and
calculating parking fee according to the payment information in response to the parking space specified by the first parking space identification information being identical to the parking space specified by the second parking space identification information.

8. A non-transitory computer readable medium storing the parking lot management program product according to claim 6.

9. A non-transitory computer readable medium storing the parking lot management program product according to claim 7.

10. A vehicle communication device equipped to a vehicle, the vehicle communication device comprising:
a first communication unit receiving parking space identification information from a parking lot communication device and transmitting vehicle identification information used for identifying the vehicle to the parking lot communication device, the parking lot communication device being installed to each parking space in a parking lot; and
a second communication unit transmitting, to an information processing device positioned outside of the vehicle, the parking space identification information that is received and the vehicle identification information.

11. The vehicle communication device according to claim 10, wherein
the first communication unit performs a short-range wireless communication.

12. The vehicle communication device according to claim 11, wherein
the first communication unit includes a transmitter transmitting low frequency waves and a receiver receiving ultra high frequency waves.

13. The vehicle communication device according to claim 10, wherein
the second communication unit performs a low power consumption wide area wireless communication.

14. A parking lot communication device installed to each parking space of a parking lot, the parking lot communication device comprising:
a first communication unit receiving, from a vehicle communication device equipped to a vehicle, vehicle identification information used for identifying the vehicle, and the first communication unit transmitting, to the vehicle communication device, parking space identification information used for identifying a parking space to which the parking lot communication device is installed; and
a second communication unit transmitting the vehicle identification information that is received and the parking space identification information to an information processing device positioned outside of the parking lot communication device.

15. The parking lot communication device according to claim 14, wherein
the first communication unit performs a short-range wireless communication.

16. The parking lot communication device according to claim 15, wherein
the first communication unit includes a transmitter transmitting ultra high frequency waves and a receiver receiving low frequency waves.

17. The parking lot communication device according to claim 14, wherein
the second communication unit performs a low power consumption wide area wireless communication.

18. The parking lot communication device according to claim 17, wherein
the second communication unit changes an information transmission interval to the information processing device according to a time slot of one day.

19. The parking lot communication device according to claim 17, wherein
the second communication unit changes an information transmission interval to the information processing device according to an empty rate of the parking lot or according to a quantity of empty parking spaces in the parking lot.

20. A vehicle communication device equipped to a vehicle, the vehicle communication device comprising:
a receiver receiving, from an information processing device, first parking space identification information and second parking space identification information, the first parking space identification information being designated by a user in a reservation of a parking lot, the second parking space identification information being transmitted from a parking lot communication device to the information processing device, each of the first parking space identification information and the second parking space identification information indicating a parking space of the parking lot and being communicated between the parking lot communication device installed to each parking space of the parking lot and the information processing device positioned outside of the parking lot communication device;
a controller comparing the first parking space identification information with the second parking space identification information; and
a transmitter transmitting vehicle identification information used for identifying the vehicle to the information processing device in response to the first parking space identification information being identical to the second parking space identification information.
